(19) United States
(12) Patent Application Publication
(10) Pub. No.: US 2023/0325754 A1
(43) Pub. Date: Oct. 12, 2023

(54) SYSTEMS AND METHODS FOR QUALITY CONTROL MANAGEMENT

(71) Applicant: Christopher Brandon De Young, Fresno, CA (US)

(72) Inventor: Christopher Brandon De Young, Fresno, CA (US)

(21) Appl. No.: 18/332,145

(22) Filed: Jun. 9, 2023

Related U.S. Application Data
(63) Continuation of application No. 18/073,357, filed on Dec. 1, 2022.
Application No. 18/073,357 is a continuation of application No. 17/119,920, filed on Dec. 11, 2020, now abandoned.
(60) Provisional application No. 62/946,684, filed on Dec. 11, 2019.

(51) Int. Cl. G06Q 10/0639; G06Q 50/08; G06Q 10/0631; G06K 19/06; G06Q 10/20; G06K 15/02

(52) U.S. Cl. CPC G06Q 10/06395; G06Q 50/08; G06K 15/024; G06K 19/06037; G06Q 10/20; G06Q 10/06316

(57) ABSTRACT

A quality control management system, and methods therefor, comprising a tracking and labeling system for construction defects. A labeling system may include uniquely machine-coded and computer-readable labels which may be placed near the location of a defect. The labeling system may also use alphanumeric codes and color-coded schemes to uniquely identify the nature and characteristics of a defect. A defect tracking system may be in the form of mobile application software which can be integrated with the labeling system. The mobile application software may be accessible on a mobile device, such as a smartphone, allowing a user to take a scan, or take a picture of, a label with their mobile device camera and automatically, or manually, associate various types of information with a corresponding defect. The mobile application software may allow users to create, view, and edit defect lists, as well as monitor and manage the workflow of defect repairs.

### CROSS-REFERENCE TO RELATED APPLICATIONS

This application is a continuation of U.S. Nonprovisional patent application Ser. No. 18/073,357, filed Dec. 1, 2022, which is a continuation of U.S. Nonprovisional patent application Ser. No. 17/119,920, filed Dec. 11, 2020, which claimed priority to, and the benefit of, U.S. Provisional Patent Application No. 62/946,684, filed Dec. 11, 2019, each of which are hereby incorporated by reference in their entirety.

### FIELD OF THE INVENTION

The present invention concerns quality control management systems for home builders and contractors. More particularly, some embodiments of the present invention concern systems and methods for identifying, cataloging, and repairing defects throughout the home construction process.

### BACKGROUND OF THE INVENTION

In the home construction industry, a critical part of the building process is maintaining quality control throughout each phase—making sure each phase is completed in an effective and thorough manner. This includes regular inspections of a job site to ensure that any defects in the workmanship of contractors and subcontractors are promptly identified. The extent of such defects may include, for example, damage to flooring, countertops, or appliances, as well as minor cosmetic issues, such as nicks or chips in wall paint. Regardless of the nature, typically, all defects that come about during the building process are marked and repaired before a job is complete.

To ensure that defects are repaired in a timely and acceptable fashion, it is important for inspectors, job site supervisors, or any other type quality control personnel to mark and catalog defects during quality inspection walkthroughs and then provide a listing of the defects to the appropriate subcontractor(s) so they are aware of what repairs are needed. Conventionally, methods of marking and cataloging defects during the construction process consists of sticking a small piece of blue painter's tape (or the like) next to a defect and then writing down a description of the defect on a notepad. Typically, a list of defects with corresponding descriptions is left at the job site and the appropriate subcontractors are contacted to schedule the necessary repair work by quality control and construction management personnel.

Unfortunately, there are numerous problems with conventional systems and methods of quality control management. For example, if a list of defects is handwritten, there are potential issues with legibility, which may lead to confusion and, thus, require additional time to clarify the defects before any repairs are started. Additionally, if the list is left on the job site, it could potentially get lost, misplaced, or inadvertently discarded, which may cause further delay. Furthermore, if a defect is marked by a generic piece of tape, or similar means, in some cases, it may be unclear as to exactly what is the nature and location of the defect. Notwithstanding the above, there exists inherent inefficiencies with manually labeling and cataloging defects and sharing the defect list with subcontractors in accordance with conventional means.

Therefore, there exists a need for a quality control management system which allows personnel to label, catalog, and share defects in a timely and efficient manner, while also providing clarity so that defects are easily identifiable at a job site. Furthermore, there exists a need for a system which allows builders and subcontractors to view and edit a defects list in real time without having to be physically present at a job site.

### BRIEF SUMMARY OF THE INVENTION

The present invention generally comprises a construction defect tracking system and a physical labeling system, which may be cooperatively used as a management tool to efficiently organize and monitor defects at a job site, and to delegate appropriate personnel to repair projects. In preferred embodiments, the present invention may allow home builder quality control personnel (or the like) to i) label and catalog defects at a job site, ii) notify trade partners (e.g., contractors or subcontractors) of the defects, iii) provide access to a defects list so that the subcontractors are aware of needed repairs, and iv) track the repair of each defect from cataloging to completion.

A defect tracking system may be in the form of mobile application software (hereinafter, “application”) which may be downloaded and accessed on a mobile device via one or more servers. In some embodiments, a defect tracking system may also be in the form of web-based software or a website, such that it may be accessed on a non-mobile device. A labeling system may comprise machine-coded, computer-readable mediums, such as bar codes and/or quick response (“QR”) codes, or the like, which may be readable by the mobile application software. A labeling system may also utilize alphanumeric codes and/or color-coding schemes to classify and uniquely identify defects.

In some embodiments, a label printer, which may be native to the application, may be used to print unique labels for each defect at a job site. A printed label may be machine-coded and/or colored to provide unique information about a corresponding defect. In some implementations of the present invention, builder personnel may place one or more labels on a surface adjacent to a defect during quality control inspection as a project nears completion. The builder personnel may then use the application to scan the label (or a machine code thereon) and to take a photograph of a defect to be associated with the label. Then, the builder personnel may annotate what the defect is regarding, its location, and any other important details which may be useful to the trade partner(s) responsible for repairing the defect—in some implementations, this information may be automatically extracted from the label. A list of defects may be made available by the application for appropriate users and synchronized to a shared internet database, such that a builder can create and organize a workflow process and such that any associated trade partners can log in to the application and, among other things, view, schedule, update, and check off items as they are completed in real time.

According to some embodiments of the present invention, a system for quality control management may comprise: a server having a memory having a database; a plurality of labels for identifying a construction defect, wherein each label may comprise a unique label identifier; and a mobile device which may be operatively connected to the server, wherein the mobile device may comprise a camera and an application executing on the mobile device and wherein the application may be configured to: i) obtain an image of a first of the labels from the camera and identify the label identifier therefrom; ii) generate a trade identifier and a defect identifier from the label identifier; and iii) update an electronic record of the defect in the database of the server, wherein the electronic record may comprise a record identifier, the trade identifier, the defect identifier, and at least one attribute identifier associated with the defect.

In a further embodiment, the at least one attribute identifier may be a defect description identifier, a trade category identifier, a trade partner identifier, a defect type identifier, or a location identifier, and combinations thereof.

In another further embodiment, the quality control system may further comprise a printer operatively connected to the mobile device and configured to print each label identifier on each of the labels. In an even further embodiment, the application of the quality control system may be further configured to generate the label identifier in response to information saved in the database of the server.

In another further embodiment, the application of the quality control system may be further configured to obtain an image of the defect from the camera of the mobile device and send the image to the server.

In another further embodiment, a color of one of the labels may correspond to a first trade category.

In another further embodiment, the label identifier may be a bar code having at least one dimension. In an even further embodiment, the bar code may have at least two dimensions.

According to some embodiments of the present invention, a method for quality control management may comprise the steps of: a) affixing a label adjacent to a construction defect, wherein the label may comprise a label identifier; b) storing the label identifier, a defect identifier, and a trade identifier in an electronic record of the defect, wherein the record may be in a database in a memory of a server; and c) repairing the defect according to one of a plurality of workflow processes.

In further embodiment, the step of storing the label identifier, the defect identifier, and the trade identifier in the electronic record of the defect may comprise storing at least one attribute identifier of the defect in the record. In an even further embodiment, the at least one attribute may be a trade category, a trade partner, a defect type, or a location, and combinations thereof.

In another further embodiment, one of the plurality of workflow processes may be determined by a defect type.

In another further embodiment, a first one of the workflow processes may comprise the step of: i) notifying a first trade partner of the defect; and ii) updating a status of the record. In an even further embodiment, the first one of the workflow processes may further comprise the steps of: iii) notifying the first trade partner to perform repairs to the defect; and iv) updating a status of the record. In an even further embodiment, the first one of the workflow processes may further comprise the steps of: v) notifying a second trade partner to perform repairs to the defect; and vi) updating a status of the record. In an even further embodiment, the first one of the workflow process may further comprise the steps of: vii) notifying a builder of the status of the defect; and viii) updating a status of the record. In a further embodiment, a status of the defect may be updated after the first trade partner or the second trade partner has performed repairs to the defect.

In another further embodiment, a second one of the workflow processes may comprise the steps of: i) notifying a third trade partner of the defect; and ii) updating a status of the record.

In another further embodiment, a color of the label may correspond to a trade category.

In another further embodiment, the label identifier may be a bar code having at least one dimension. In an even further embodiment, the bar code may have at least two dimensions.

In another further embodiment, the method for quality control management may further comprise the step of: d) preparing the label by printing the label identifier on the label using a printer.

In another further embodiment, the step of storing the label identifier, the defect identifier, and the trade identifier in the electronic record of the defect may comprise obtaining an image of the label and identifying the label identifier therefrom with a camera of a mobile device.

In another further embodiment, the step of storing the label identifier, the defect identifier, and the trade identifier in the electronic record of the defect may comprise obtaining an image of the defect with a camera of a mobile device.

### BRIEF DESCRIPTION OF THE DRAWINGS

FIG. 1 is a flowchart illustrating exemplary steps prior to cataloging defects in accordance with some embodiments of the present invention.

FIG. 2 is a diagram illustrating an exemplary interface of an application in accordance with some embodiments of the present invention.

FIG. 3 is a diagram illustrating an exemplary interface of an application in accordance with some embodiments of the present invention.

FIG. 4 is a diagram illustrating an exemplary interface of an application in accordance with some embodiments of the present invention.

FIG. 5 is a diagram illustrating an exemplary interface of an application in accordance with some embodiments of the present invention.

FIG. 6 is a diagram illustrating an exemplary interface of an application in accordance with some embodiments of the present invention.

FIG. 7 is a flowchart illustrating exemplary steps for cataloging a defect in accordance with some embodiments of the present invention.

FIG. 8 is a diagram illustrating an exemplary interface of an application in accordance with some embodiments of the present invention.

FIG. 9 is a diagram illustrating an exemplary interface of an application in accordance with some embodiments of the present invention.

FIG. 10 is a diagram illustrating an exemplary interface of an application in accordance with some embodiments of the present invention.

FIG. 11 is a diagram illustrating an exemplary interface of an application in accordance with some embodiments of the present invention.

FIG. 12 is a diagram illustrating an exemplary interface of an application in accordance with some embodiments of the present invention.

FIG. 13 is a diagram illustrating an exemplary interface of an application in accordance with some embodiments of the present invention.

FIG. 14 is a diagram illustrating an exemplary interface of an application in accordance with some embodiments of the present invention.

FIG. 15 is a diagram illustrating an exemplary interface of an application in accordance with some embodiments of the present invention.

FIG. 16 is a diagram illustrating an exemplary interface of an application in accordance with some embodiments of the present invention.

FIG. 17 is a diagram illustrating an exemplary interface of an application in accordance with some embodiments of the present invention.

FIG. 18 is a diagram illustrating an exemplary interface of an application in accordance with some embodiments of the present invention.

FIG. 19 is a diagram illustrating an exemplary interface of an application in accordance with some embodiments of the present invention.

### DETAILED DESCRIPTION OF THE INVENTION

The invention, in its various aspects, will be explained in greater detail below. While the invention will be described in conjunction with several exemplary embodiments, the exemplary embodiments themselves do not limit the scope of the invention. Similarly, the exemplary illustrations in the accompanying drawings, where like elements have like numerals, do not limit the scope of the exemplary embodiments and/or invention, including any length, angles, or other measurements provided. Rather the invention, as defined by the claims, may cover alternatives, modifications, and/or equivalents of the exemplary embodiments.

The present invention generally combines a construction defect tracking system, in the form of mobile application software, or web-based software, (hereinafter the “application”), and a physical labeling system. The application may be downloaded and/or accessed on a mobile device, such as a smartphone or tablet, connected to one or more servers having a database. The defect tracking system may also be accessible via a non-mobile device, such as a desktop or personal computer. In some embodiments, the application may allow both mobile and non-mobile devices to connect to one or more servers to access a central database which may store secured information related to a builder's job sites. In general, the application may be particularly adapted for home builders and their trade partners, wherein the functionality of the application may be specific to the type of user (i.e., builder or trade partner). It is to be understood that the terms “builder” and “trade partner” may generally refer to any type of personnel which may be involved, directly or indirectly, with a particular construction project.

In some aspects, the present invention provides a system by which builders can manage and maintain quality control throughout a construction project. In some embodiments, for builder personnel (sometimes referred to hereinafter as a “builder user”), the application may provide options to i) create, edit, and/or share a defects list, ii) view high-level statistics related to defects, iii) view and edit the progress of current and completed (i.e., repaired) defect lists, and iv) view trade partner statistics. For example, a builder user may perform a quality control inspection of a job site, during which the builder user can create a real-time list of all defects found at the job site. This list can then be shared with the appropriate trade partner(s), notifying them of the necessary repairs. In addition, a builder user may be able to view statistics, such as average number of defects per job site (or lot) and average completion time by defect and/or by job site. A builder user may also be able to view similar statistics for trade partners, such as their average completion time and their average or total number of defects.

The present invention also provides a system by which trade partners can view and manage defects. For example, using the application, trade partner personnel (sometimes referred to hereinafter as a “trade user”) may be able to view defect lists, add any relevant or important information (e.g., notes, pictures, etc.), and designate or update the status of a particular defect repair (e.g., not started, in progress, or completed). Additionally, a trade user may be able to view statistics and information related their performance and be notified of the same. For example, a trade user may be able to view an average number of defects by job site and track the progress of defect repairs by defect type and/or job site. From this information, the application may provide an indication of any defect repairs which are urgent and/or behind schedule.

### Pre-Cataloging Steps

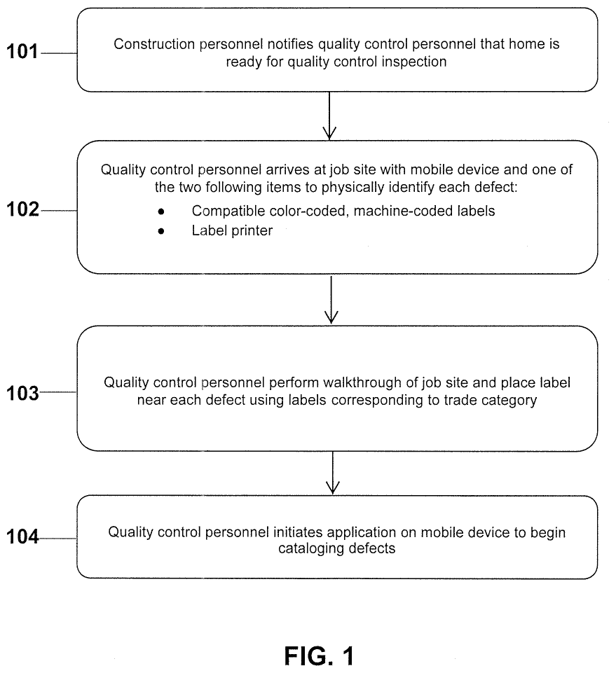

In one implementation of the present invention, a quality control management process may be initiated according to Steps 101-104 of FIG. 1. In Step 101, construction (builder) personnel may notify quality control personnel that a home is ready for a quality control inspection. Following, in Step 102, quality control personnel may arrive at the job site with i) a mobile device (sometime referred to hereinafter as “user device”) equipped with the application and ii) labels for physically identifying defects, such as compatible color-coded and/or machine-readable labels. In some embodiments, a label printer, which may be native to the application, may be used to print uniquely coded information which may be readable only by the application. In some implementations, a printed label may comprise i) one or more colors corresponding to one or more trades (e.g., blue for painters, green for electricians, grey for masonry, etc.) and ii) one or more unique identifiers (such as alphanumeric codes) which may be associated with a defect. For example, an identifier may be a one-dimensional bar code (e.g., universal product code, or “UPC”) or a two-dimensional bar code (e.g., quick response, or “QR” code). In some aspects, a color may be provided to visually differentiate between defect types, whereas a label identifier may encode this information. In other aspects, however, a color may be readable by the application to determine the defect type. In some embodiments, a label may be pre-colored and/or pre-coded. In such implementations, a user may choose a particular color to print a label identifier on, based on the nature of the defect. If a set of labels are pre-coded, for example, a user may choose not to print label identifiers and instead use sequentially coded labels for a particular set of related defects.

Following Step 102, in Step 103, quality control personnel may perform a walkthrough of the job site and affix a label on a surface adjacent to each defect (or, if needed, on the back of the front door, such as for exterior defects), using specific labels which correspond to the defect trade category(ies) (e.g. tile, paint, etc.). In some embodiments, quality control personnel may supplement labels with blue painter's tape for defects that consist of many small defects (e.g., nicks, dings, or marks in paint, cabinetry, etc.). After all labels have been affixed near a corresponding defect, in Step 104, quality control personnel may initiate the application on their mobile device to begin cataloging the defects.

### Using the Application

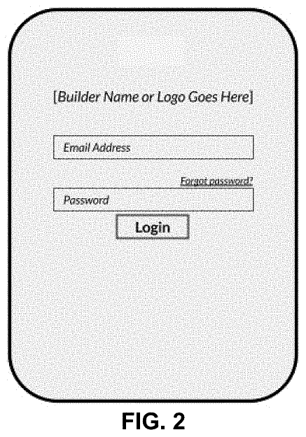

Once the application has been initiated on a builder user's device, the device screen may initially display a login page prompting the user to log in with their credentials (e.g., email address and password), as illustrated, for example, in FIG. 2. If the user has forgotten their login credentials, an option may also be provided to recover this information. In some implementations, if the user is not registered, there may be an option to register an account. After login, the user may be able to navigate the application in accordance with any user-specific restrictions which may be enabled. In some embodiments, one or more text fields displayed throughout the various pages of the application may be predictive. For example, as a user types within a job name text field, it may automatically start to fill in with the closest possible job name and continuously update with each character typed. It may also list other similar choices that the user can select.

### ‘User Menu’

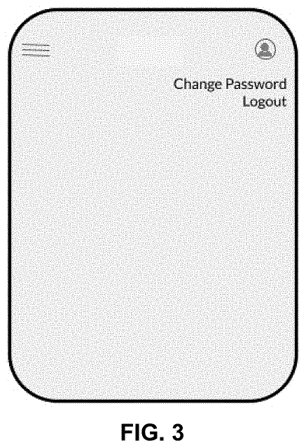

In some embodiments, once a user is logged in, a selectable icon may be available on any page of the application which, when selected, may display a user menu. For example, as illustrated in FIG. 3, an icon may be displayed in the upper right corner of the user device screen which, when selected, may display ‘User Menu’. The ‘User Menu’ may display two options to the user: i) ‘Change Password’; and ii) ‘Logout’, as also illustrated, for example, in FIG. 3.

### ‘Main Menu’

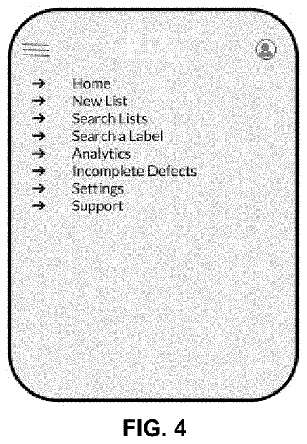

According to some embodiments, when the application is open on a builder user's device, a selectable icon or object may be available on the builder user's device screen from which a menu may be selected at any time. For example, referring, generally, to FIG. 4, when the application is started on the builder user's device, at the top left of the device screen there may be three parallel dashes that the user can select. When they do so, or if they swipe from the left screen edge to the right, a ‘Main Menu’ may slide into view from the left screen edge. In some embodiments, before the user signs in, the ‘Main Menu’ may only reflect the following pages or options: i) ‘Sign In’—This option may be provided so that if the user selected the ‘Support’ page, they can get back to the ‘Sign In’ page; and ii) ‘Support’. In other embodiments, a selectable object from which the ‘Main Menu’ may be accessed may not be available to the user until after login.

### ‘Main Menu’—After Login

According to some embodiments, regardless of which page the builder user is on within the application, the user can view the ‘Main Menu’ at any time by selecting the corresponding object on the user device screen. For example, as further illustrated in FIG. 4, the builder user may view the ‘Main Menu’ by selecting the three dashes at the top left of the user device screen (or by swiping from the left screen edge to the right) to view a list of pages to which the builder user can navigate. The ‘Main Menu’ may reflect the following application pages: i) ‘Home’; ii) ‘New List’; iii) ‘Search Lists’; iv) ‘Search a Label’; v) ‘Analytics’; vi) ‘Incomplete Defects’; vii) ‘Settings’; and viii) ‘Support’. By selecting any of these pages, the application may navigate to the corresponding page.

### ‘Horne’ Page

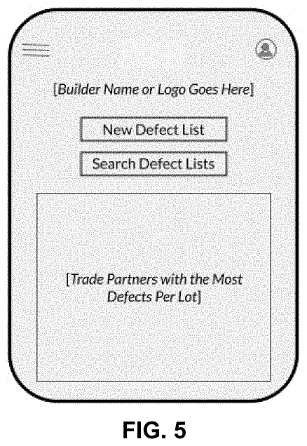

By selecting ‘Home’ from the ‘Main Menu’, the user may be navigated to the corresponding page where additional selectable options, lists, and/or charts may be displayed. In some embodiments, the ‘Home’ page may be the initial page displayed after a user logs in to the application. As illustrated in FIG. 5, for example, in some embodiments, the ‘Home’ page may depict the builder's name or company logo at the top of the device screen, which can be entered, or uploaded, and configured in the ‘Settings’ page. Displayed on this page may be two selectable options: i) ‘New Defect List’ and ii) ‘Search Defect Lists’. By selecting either option, the application may automatically navigate to the corresponding page.

According to some embodiments, the ‘Home’ page may display one or more lists and/or charts which may, for example, comprise analytical and/or statistical information. For example, and without limitation, below the ‘New Defect List’ and ‘Search Defect Lists’ options may exist a list or chart which may automatically populate information based on criteria which may be predefined by the user in the ‘Settings’ page. For instance, displayed on this page may be a listing of i) the most urgent, incomplete defects lists, ii) average defects per lot, and/or ii) trade partners (or subcontractors) with the most defects per lot. In preferred embodiments, data depicted in this chart may be extracted directly from the builder's quality control database. The user can select any of the information listed within a chart or list and be navigated to the corresponding page in the application to review or edit the information selected. For example, and without limitation, if a defect list is selected from a listing of urgent, incomplete defect lists, then the application may navigate to the corresponding page where the user may review and edit the selected defect list. Similarly, if a trade partner is selected from a list of trade partners with the most defects per lot, the application may navigate to a corresponding page where the user may review defect statistics pertaining to the selected trade partner.

### ‘New Defect List’ Page

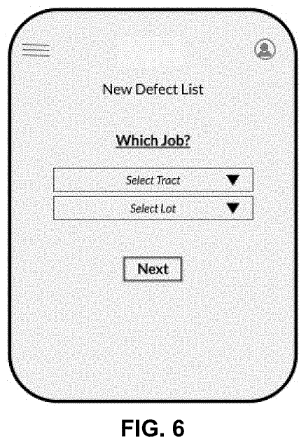

When a user has navigated to the ‘New Defect List’ page, the user may follow a series of steps to create a new defect list. For example, to create a new defect list, the builder user may start by selecting the ‘New Defect List’ option on the ‘Home’ page to be directed to a corresponding page, as illustrated in FIG. 6. On this page, the user may select the lot and tract numbers of the job from a dropdown list for which the user wishes to create a new defect list. Once the user has selected a job (e.g., by selecting ‘Next’ on the ‘New Defect List’ page), the application may navigate to the first step of the ‘New Defect List’ process. In preferred embodiments, the selectable options for the tract and lot numbers may be populated by the application database configured through the ‘Settings’ page. Alternatively, in some embodiments, the application may allow a user to manually enter a job address, lot number, and/or tract number. If the step of creating a new defect list has already been completed for a job, the application may not allow any additional lists to be created. However, if a user attempts to do so, the application may prompt the user that a list has already been created for the job and may provide an option to review and/or edit the corresponding defect list, or to choose a new job. In some embodiments, the application may be integrated with a mobile device's GPS location. For example, and without limitation, if a device's GPS location is enabled, the application may be able to automatically determine the location of a job site and associate corresponding lot and tract numbers therewith.

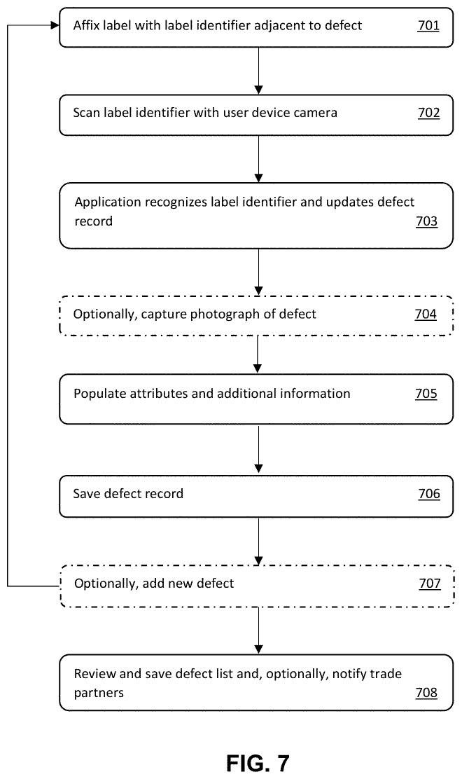

Once a new defect list has been created, the application may navigate to a new page, where the user may be prompted to catalog a series of defects through a repeated process of image scanning/capture and data input/extraction for each defect, creating and updating a series of electronic records stored in a server database. Exemplary steps which may be involved with the defect cataloging process is illustrated in FIG. 7 In preferred embodiments, one or more printed labels comprising unique human-readable and/or machine-readable identifiers, which may encode information about one or more corresponding defects, may be used in the image capture process. This identifier may allow the application to automatically populate attributes about a defect, such as trade category and/or a unique defect identifier or code, based on the color(s) and/or code(s) that are scanned. Alternatively, in some embodiments, the user can select an option to bypass the image capture step and manually enter data for each defect. If this option is selected, the application may automatically create and assign a unique defect identifier for each manually entered defect.

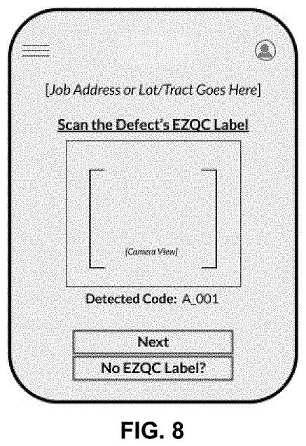

If user chooses to utilize a label, the user may first affix the label adjacent to a defect in accordance, for example, with Step 701 of FIG. 7. Following, during the image scanning step, the user may be prompted to scan a first defect label with the user device camera, as illustrated, for example, in FIG. 8. The user may then scan the label identifier with the user device camera in accordance, for example, with Step 702 of FIG. 7. Once a label identifier on the label is in view of the user device camera, the application may automatically recognize the identifier and, if successful, the application may generate a trade identifier and/or defect identifier from the label identifier and update the defect record accordingly, in accordance, for example, with Step 703 of FIG. 7. In some embodiments, as used herein, the term “generate” may refer, generally, to a process of accessing information stored in a database and decoding a label identifier which may be encoded with the stored information. For example, and without limitation, the application may generate a trade identifier by accessing information stored in a table and, using information in the table and which is encoded in a label identifier, decode the label identifier. In some embodiments, upon completion, the label identifier may appear on the user device screen and the user may proceed to the next step (e.g., by selecting ‘Next’). In some cases, the application may prompt the user to capture a photograph of the label with the corresponding defect in view. Once captured, the application may show the image preview to the user along with options to accept the captured image, capture more label images, and/or reject the captured image. For example, once an image of a label is captured, the following three selectable options may be available to the user: i) “Accept. No more labels for this defect.”—If this option is selected, the image may be saved and the application may transition to the next step; ii) “Accept. More labels to capture for this defect.”—If this option is selected, the image may be saved and the application may transition back to the camera scan view; iii) “Try again.”—If this option is selected, the image may be discarded and the application may transition back to the camera scan view.

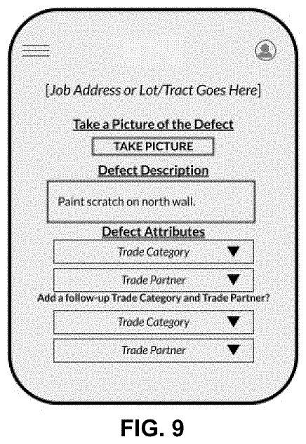

Following the image scanning step, the application may prompt the user to take a picture of the defect corresponding to the scanned (and/or photographed) label in accordance, for example, with optional Step 704 of FIG. 7. For example, as illustrated in FIG. 9, the user may select the ‘Take Picture’ icon to initiate the user device camera. Once the photograph is captured, the image taken may be viewable in a photograph editor view which may allow the user to draw on, and/or add text and shapes to, the image (e.g., to add a line or arrow pointing to the defect). Once the user is finished with any edits, the application may provide a selectable option to save the image, after which the defect record may be updated, the editor view may close, and a thumbnail of the captured and edited image may be displayed on the user device screen. If the user would like to discard the image and take a new picture, the application may also provide a selectable option to do so.

In some embodiments, the application may display three options to the user while the photograph editor view is active: i) “Accept. No more pictures.”—If this option is selected, the picture may be saved and the application may automatically transition to the next page; ii) “Accept. Take more pictures.”—If this option is selected, the picture may be saved and the application may transition back to the camera view to allow the user to take another picture; iii) “Try again.”—If this option is selected, the picture may be discarded and the application may transition back to the camera view to allow the user to take another picture. During this step, the application may also provide an option for the user to enter in a text description of the defect, as further illustrated, for example, in FIG. 9.

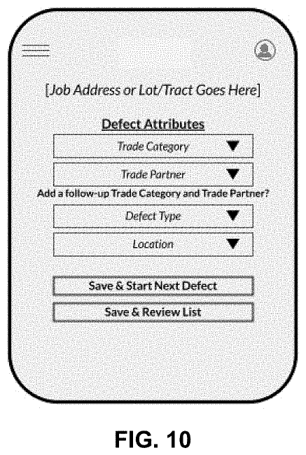

In a next step, and in accordance, for example, with Step 705 of FIG. 7, the application may prompt the user for a number of attributes about the defect. For example, as illustrated in FIGS. 9 and 10, the application may prompt the user to specify, from a dropdown menu, the trade category(ies) and trade partner(s) associated with the defect. If the user has labeled a defect with a label having a printed identifier and has configured the labels for use via the ‘Settings’ page, the application may associate information encoded on the label (e.g., type of defect, the trade category(ies) and trade partner(s) associated therewith, and, if applicable, the order in which the trade partners should complete their repairs) and may automatically populate this information into the defect attributes. For example, if the user scanned a label identifier which had been previously associated with a specific trade category, then the trade category may automatically populate in the corresponding field. Similarly, if the user scanned a label identifier which had been previously associated with a trade category and an association had been previously made between a specific company and the trade category, then the company may automatically populate in the ‘Trade Partner’ field. Regardless of whether labels are used, a user may be able to make any manual adjustments, as needed.

In some embodiments, the application may allow follow-up trade categories and trade partners to be attributed to each defect when, for example, more than one trade partner is needed to completely repair a defect. For instance, a defect requiring drywall repair may include the installation of new drywall, as well as new paint, which may involve multiple trade partners. As illustrated in FIGS. 9 and 10, for example, the application may provide a selectable option for the user to add as many additional trade categories and trade partners as needed.

In some embodiments, repairs by trade partners may be delegated according to specific workflow processes, which, for example, may be dependent on the defect type and the trade categories involved. For instance, a defect may need to be repaired in stages, thus involving several trade partners. As a result, the workflow process may be structured so that each trade partner completes their repairs, sequentially, in accordance with the order that the repairs will take place.

In addition to the ‘Trade Category’ and ‘Trade Partner’ attributes, the application may also provide selectable options for indicating the type of defect and its location. If previously configured in the ‘Settings’ page of the application, this information may automatically populate in the corresponding fields. Once the defect attributes are specified (manually or automatically), the application may provide selectable options to update and save the electronic record of the current defect in accordance, for example, with Step 706 of FIG. 7 and either i) repeat the appropriate steps to add another defect (e.g., optional Step 707 of FIG. 7), or ii) review the current defect list before finalizing, as illustrated, for example, in FIG. 10.

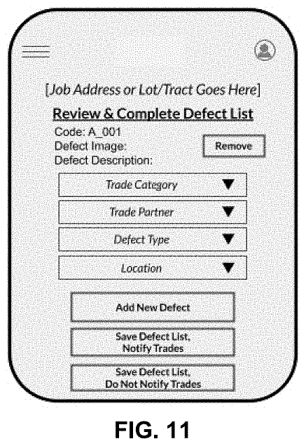

Once the user has saved the current defect list, the application may navigate to a new page displaying all defects in the current list. Referring, generally, to FIG. 11, for example, the application may provide a scrolling list of every defect that has been entered for the current list and their corresponding electronic records which may list information associated with each defect including, but not limited to, the corresponding label and/or record identifier, images of the label and/or defect, the defect description, and the corresponding attributes. In some embodiments, the application may allow a user to review, edit, add, and/or remove any defects as needed before moving to the next step, as also illustrated, for example, in FIG. 11. To finalize the defect list, the application may provide the user with options to save and update the defect list and either i) notify the trade partners associated with the defects, or ii) not notify the trade partners associated with the defects in accordance, for example, with Step 708 of FIG. 7. For example, as further illustrated in FIG. 10, the user may select from two selectable options: i) “Save Defect List, Notify Trades” and ii) “Save Defect List, Do Not Notify Trades”. The application may allow the user to edit any information entered or populated during previous steps, prior to saving and moving forward.

In some embodiments, a defect list may be sorted by trade category and further sorted by the order in which each category's defects were labeled. According to some aspects, the application may determine the order in which defects were labeled based on the type of labels used and/or any indicia thereon. For example, and without limitation, a set of labels may be pre-coded in accordance with their order within the set, such that the labels may be sequentially tracked as they are logged by the application. This information may then be used, for example, to automatically designate the order in which defects are to be repaired.

Once the user has saved the defect list and has chosen to notify the associated trade partners, the defect record may be updated and each trade partner may be automatically notified of the defect and provided with information regarding the same. If more than one trade category and trade partner were specified for a defect, all trade partners may be notified at the same time of the defect. However, in preferred embodiments, any trade partner which was added to a defect as a “follow-up” trade partner may receive a message, warning, alert, or notification, or the like, directing them not to begin repairs until all repairs by any preceding trade partners are completed (to control the workflow process—ensuring that the repairs are completed in proper order and so that multiple trade partners are making repairs to a defect at the same time). For example, on a trade partner user's device, the phrase “Hold Until Trade Before You Completes Their Work” may be displayed next to the corresponding defect on the list of defects. Then, once either a schedule date has been entered by the builder user or trade partner user for the first trade partner to complete their work for the defect, or the first trade partner has updated the defect record to indicate that their repairs are complete, the next trade partner in the sequence may receive a follow-up notification, or message, of the defect's current status so that the next trade partner can plan accordingly.

### ‘Search Defect Lists’ Page

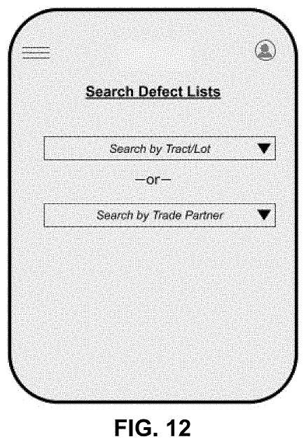

According to some embodiments, the application may provide the ability to search for defect lists. For example, as illustrated in FIG. 12, the application may provide a ‘Search Defect Lists’ page, which may allow a user to easily search for a specific defect list by either i) manually entering in the job address, or lot and tract number, and selecting a ‘Search’ option, ii) selecting from a dropdown list of jobs, or iii) by selecting from a dropdown list of trade partners. When a selection is made, the application may navigate to the corresponding page to review the selected defect list.

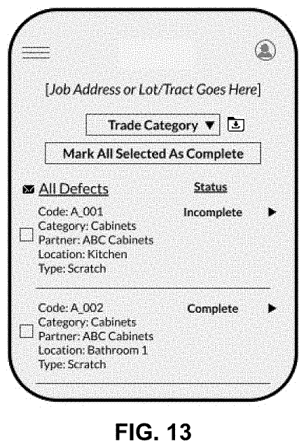

If the user selects a specific tract/lot, the application may navigate to a ‘Lot Defect List Review’ page (see, e.g., FIG. 13), where the user can view a defect list associated with the tract/lot, edit any information (which may automatically trigger a notification to any applicable trade partners, if previously configured in the ‘Settings’ page), view and edit the completion or scheduled status of each defect repair, and resend a notification to any trade partner associated with one or more defects on the list.

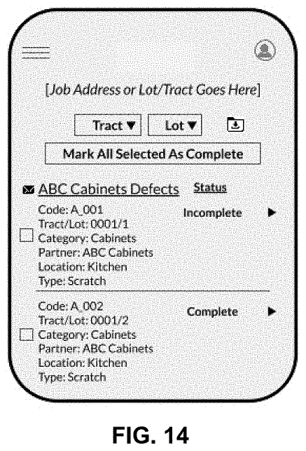

If the user selects a specific trade partner from the ‘Search Defect Review’ page, the application may navigate to a ‘Trade-Specific Defect List Review’ page (see, e.g., FIG. 14). Similar to the ‘Lot Defect List Review’ page, the user can view a list of defects associated with the trade partner, edit any information (which may automatically trigger a notification to the trade partner, if previously configured in the ‘Settings’ page), view and edit the completion or scheduled status of each defect repair, and resend a notification to the trade partner associated with the defect list. This page may only display defects that are associated with the selected trade partner.

On a defect list review page, the defect list may show static information about each defect, however, in some embodiments, there may be a selectable option next to each defect allowing the user to be navigated to a ‘Defect Detail Review’ page where the user can edit any information about the defect, remove the defect from the list, and/or adjust the scheduled or completion status of the repair of the defect. Once the user is finished with any changes and has saved those changes, the user may be navigated back to the ‘Trade-Specific Defect List Review’ or ‘Lot Defect List Review’ page. Also on the this page, the application may provide the ability for a user to do the following: i) filter the list by trade category (e.g., via a dropdown menu); ii) download a report showing the list in view; and iii) select any or all defects within the list and mark all selected defects as complete and indicating the completion date.

Initially, corresponding records of a defect list may be read-only and a selectable option may be provided to edit the information. For example, a selectable option may be provided which displays “Unlock to Edit”. After the user selects the option to edit information, a selectable option may be provided to save the entered information and the information may become editable to allow changes. In some embodiments, the selectable option to edit defect information may be translated into a selectable option to save the edited information. For example, the selectable option displaying “Unlock to Edit” may, after being selected, switch to display “Save & Lock”.

In some embodiments, the defects listed on the ‘Search Defects Lists’ page may be condensed to allow for easy viewing. For example, and without limitation, the only information which may be displayed about the defect record may be the defect identifier (ID) and completion/schedule status. If a user wants to see more detail, they may be able to select an option to expand the defect information. For example, and without limitation, the user may select an arrow (or the like) to the side of a defect code and all of a defect's information may be displayed. By selecting the arrow a second time, the user may be able to “collapse” the expanded information and revert to the original view.

### ‘Incomplete Defects’ Page

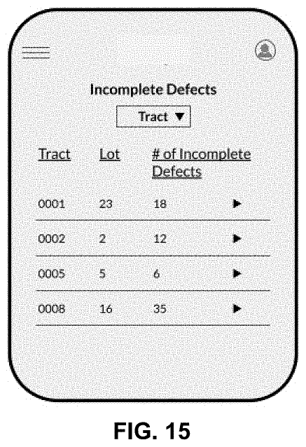

In some embodiments of the present invention, the application may provide the ability to review a list of incomplete defects (i.e., defects which have not been completely repaired) and edit any incomplete defects, as well as filter the list by a specific tract number. For example, as illustrated in FIG. 15, the application may provide an ‘Incomplete Defects’ page where the user can view which tracts/lots have incomplete defects. On this page, the application may provide a selectable option for each tract/lot which may navigate the user to an ‘Incomplete Lot Defect List Review’ page, which may only display the incomplete defects associated with a selected tract/lot. Similar to the ‘Lot Defect List Review’ and ‘Trade-Specific Defect List Review’ pages, the user can view a list of incomplete defects associated with a particular tract/lot, edit any information (which may automatically trigger a notification to any associated trade partner(s), if previously configured in the ‘Settings’ page), view and edit the completion or scheduled status of each defect repair, and resend a notification to the trade partner(s) associated with the defect list.

### ‘Settings’ Page

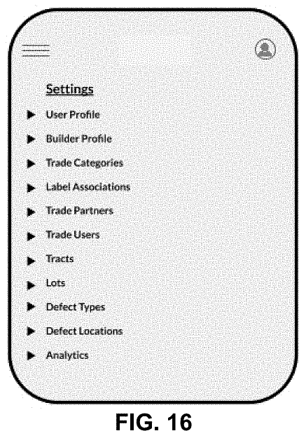

According to some embodiments of the present invention, the application may provide the ability to view and edit internal settings. For example, referring, generally, to FIG. 16, the application may provide a ‘Settings’ page by which a user may configure aspects of the application interface and database which, in some cases, may be required for certain functionality of the application. Some configurable settings topics may include, but are not limited to: ‘User Profile’, ‘Builder Profile’ (or ‘Builder Users’), ‘Label Associations’, ‘Lots’, ‘Tracts’ (or, collectively, ‘Lots and Tracts’), ‘Trade Categories’, ‘Trade Partners’, ‘Trade Users’, ‘Defect Types’, ‘Defect Locations’, and ‘Analytics’. In preferred embodiments, all settings may be accessible by administrative users, whereas only a limited set of settings may be accessible by non-administrative users. For example, for non-administrative users, only the ‘Analytics’ settings topic may be accessible.

In some embodiments, a user may be able to configure a setting by adding, editing, and/or removing the corresponding information by means of manual input, or by uploading or linking a spreadsheet. If the latter means is selected, information provided in a spreadsheet may automatically update the application database in real time.

### Settings—‘User Profile’, ‘Builder Profile’, and ‘Trade Users’ Pages

The ‘User Profile’, ‘Builder Profile’, and ‘Trade Users’ pages may allow a user to add, edit, or remove information pertaining to the user's profile, such as, but not limited to, name and email address, as well as builder level information and trade partner information, depending on which one is selected.

In some embodiments, within the ‘Builder Profile’ (or, alternatively, ‘Builder Users’) page, the application may provide a dropdown which may allow administrative users to add new users, or edit and remove existing users. By selecting an existing user from the dropdown, the application may navigate to an ‘Edit User’ page. When editing a user, fields such as user type, username, password, and email address can be adjusted.

### Settings —‘Trade Partners’, ‘Trade Categories’, ‘Tracts’, and ‘Defect Locations’ Pages

The ‘Trade Partners’, ‘Trade Categories’, ‘Tracts’, and ‘Defect Locations’ pages may show a complete list of categories, types, and locations within the builder user's database and may allow the user to add, edit, or remove information from each list. Information from each of the aforementioned pages may populate in the dropdown menus throughout other pages of the application.

In some embodiments, if a user selects the ‘Trade Partners’ setting, the application may navigate to the corresponding ‘Trade Partners’ page. This page may provide a dropdown which may allow administrative users to add new trade partners, or edit and remove existing ones. By selecting an existing trade partner from the dropdown, the application may navigate to an ‘Edit Trade Partners’ page. For example, within the ‘Edit Trade Partners’ page, an administrative user may be allowed to add new trade partner users, or edit and remove existing trade partner users. By selecting an existing trade partner user from the list, the user can edit the trade partner user's email address and/or password, or remove the user.

When a new trade partner user is added, the application may prompt the user for the name and email address of the trade partner. The application may then automatically send an email the trade partner to notify them that they are able to register as a user. In some implementations, a new trade partner may be required to pay a fee to use the application (or website, for non-mobile access) and may be provided a web link which may direct them to the application (or website). Via the mobile application or website, the trade partner can create a password and provide payment information, such as their credit card information, to pay any required fees. After the necessary steps are completed, the trade partner (now, “trade user”) may be navigated back to the ‘Sign In’ page where they will now be able to sign in.

### Settings—‘Label Associations’ Page

Under the ‘Label Associations’ page, a user may be able to associate specific trade categories with specific label types. For example, and without limitation, a user may choose to associate “paint” with label type “A” and “cabinets” with label type “B”. Creating label associations may allow the application to automatically attribute trade categories to defects during the process of adding and cataloging new defects.

### Settings—‘Trade Users’ Page

Under the ‘Trade Users’ page, a user may be able to add user profiles to the application database and make associations between a trade user and a trade partner which has already been saved in the application database.

### Settings—‘Lots’ Page

Under the ‘Lots’ page, a user may be able to add specific lots to the application database and make associations between a lot number and a tract number which has already been saved in the application database. A user may manually enter lot numbers into the application or, alternatively, the user may upload a spreadsheet comprising a list of lot numbers and make associations between each lot number and a corresponding tract number at one time.

### Settings—‘Defect Types’ Page

Under the ‘Defect Types’ page, a user may be able to add specific defect types to the application database and make associations between a defect type and a trade category which has already been saved in the application database.

If a user tries to remove a lot, tract, trade category, trade partner, defect type, and/or defect location that has a defect list or item associated with it, the application may prompt the user of this to confirm they want to continue with the removal. If the user does want to continue, the corresponding defect list or item may remain in the database, but new lists or items may not be able to be associated with the removed item.

### ‘Settings’—Analytics' Page

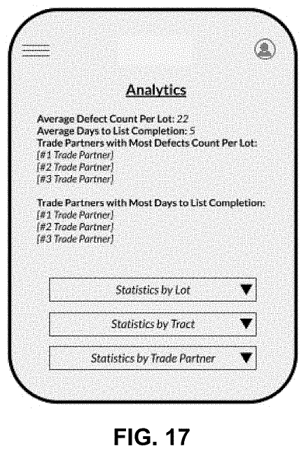

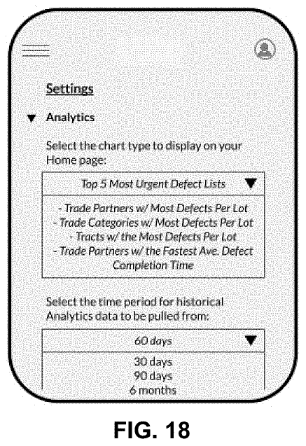

Under the ‘Analytics’ page, the application may provide the ability to review analytical information pertaining to defects, trade partners, trade categories, tracts, and lots. For example, as illustrated in FIGS. 17 and 18, the application may provide an ‘Analytics’ page which may provide a variety of statistics to the user. Such statistics may include, but are not limited to, average number of defects per lot and average number of days to list completion. Statistical information provided by the application may be in the form of raw data, tables, charts, graphs, and the like. Additionally, the application may provide the ability to download and export data in a variety of formats such that the data may be viewable as a text document, image document, or spreadsheet, or the like. Upon selection by the user, the application may either navigate to a new page with the requested information, or begin downloading the selected data.

Further to the above, in some embodiments, the ‘Analytics’ page may also provide a user with statistical information regarding defects over a period of time. For example, as illustrated in FIG. 18, a user may be able view statistics related to defects over a time range of 30, 60, or 90 days, or up to a 6-month period. The ‘Analytics’ page may allow a user to obtain valuable information by being able to view and visualize data, such as trends and patterns, which may help a user improve on their current quality control practices and processes in order to produce a better end product or service. Additional project tracking and analytics may be periodically added to the application to allow users of the application to better understand specific aspects of the quality control process, such as, for example, how quickly a particular subcontractor completes their defect repairs.

In some embodiments, the application may provide the ability for a user to select a chart (or other type of data representation) to display on the ‘Home’ page of the application, as well as the time period from which the user wants historical data on the ‘Analytics’ page to be retrieved.

### ‘Support’ Page

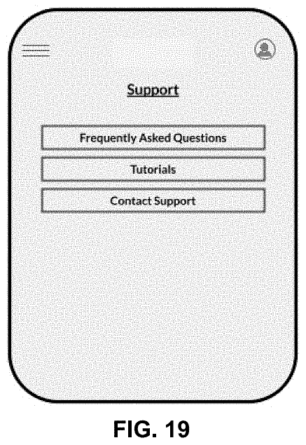

Under the ‘Support’ page, the application may provide a number of supportive features which a user may access. For example, and without limitation, as illustrated in FIG. 19, the application may provide a frequently asked questions (‘FAQ’) database, tutorials, and an option to contact customer (user) support. In some embodiments, this page may also provide options for a user to change the user type, username, password, and/or email address.

### Adaptations

It is to be understood that variations, modifications, and permutations of embodiments of the present invention may be made without departing from the scope thereof. It is also to be understood that the present invention is not limited by the specific embodiments, descriptions, or illustrations or combinations of either components or steps disclosed herein. Thus, although reference has been made to the accompanying figures, it is to be appreciated that these figures are exemplary and are not meant to limit the scope of the invention.

For example, it is to be understood that, although the present invention has generally been described in the form of a downloadable mobile application, it is to be understood that that the present invention may be in the form of a web-based application, or platform, and/or a website which may be accessible by both mobile and non-mobile devices. For example, and without limitation, a user may utilize a mobile or web-based application for cataloging information at a job site using a mobile device. However, to view data and analytics for several different job sites, a user may instead utilize a web-based application or website accessible on a desktop computer which may allow the user to more easily view and manage multiple job sites. For example, and without limitation, on a desktop computer, a user may be able to access the application to simultaneously view information related to all job sites corresponding to a particular user or builder. In some implementations, the application may provide a map showing the locations of all job sites so that a user may be able to better visualize the progress of defect repairs.

Furthermore, it is to be appreciated that the present invention may also be used to track and manage personnel involved with a particular job site. For example, and without limitation, the application may also allow a user to track the GPS location of a subcontractor responsible for repairing one or more defects. With this capability, the user may be able to ensure that a subcontractor arrives at a particular job site on-time and completes their repairs in a timely manner. This capability may also enable the user to better coordinate projects and tasks by being able to see when trade partners are present at a job site. For example, if a subcontractor has left a job site, but has not completed their repair (or has not otherwise indicated so via the application), a user may choose to send a different subcontractor to the job site to work on the same, or different, repair.

Further to the above, although the present invention has generally been described as being implemented during the last stages of a construction project, it is to be understood that the application may be used at various stages throughout a particular project. For example, and without limitation, quality control walkthroughs may occur after the completion of each phase of construction, such as after foundation preparation, framing, drywall installation, interior preparation/installations, etc. After each phase, quality control personnel may perform the defect labeling and cataloging process and the next construction phase may not begin until all cataloged defects have been repaired.

It is also to be understood that, although implementation of the present invention has generally been described relative to the residential construction industry, the scope of the present invention should not be limited by the exemplary embodiments described herein. It is to be appreciated that, given its nature, the present invention may also be adapted for other types of related industries, such as commercial construction. Even further, the present invention generally provides a convenient, efficient, and centralized quality control management system which can be adapted for consumer industries, as well as the food and drink industry. For example, the defect tracking system and/or the defect labeling system of the present invention may enable personnel to identify, track, and manage defective products and goods via a central database using uniquely coded labels which may identify various attributes related to a particular defect. Analogous to the quality control process of residential construction, quality control personnel can easily catalog defects and delegate the repairs thereof, while continuously monitoring the status of all outstanding defects.

What is claimed is:

1. A system for quality control management, comprising:
a) a server comprising a memory having a database;
b) a plurality of labels for identifying a construction defect, each of said labels comprising a unique label identifier; and
c) a mobile device operatively connected to said server, said mobile device comprising a camera and an application executing on said mobile device, said application configured to:
i) obtain an image of a first of said labels from said camera and identify said label identifier therefrom;
ii) generate a trade identifier and a defect identifier from said label identifier; and
iii) update an electronic record of said defect in said database of said server, said electronic record comprising a record identifier, said trade identifier, said defect identifier, and at least one attribute identifier associated with said defect.

2. The system of claim 1, wherein said at least one attribute identifier comprises one of the group consisting of a defect description identifier, a trade category identifier, a trade partner identifier, a defect type identifier, a location identifier, and combinations thereof.

3. The system of claim 1, further comprising a printer operatively connected to said mobile device and configured to print each label identifier on each of said labels.

4. The system of claim 3, wherein said application is further configured to generate said label identifier in response to information saved in said database of said server.

5. The system of claim 1, wherein said application is further configured to obtain an image of said defect from said camera of said mobile device and send said image to said server.

6. The system of claim 1, wherein a first color of one of said labels corresponds to a first trade category.

7. The system of claim 1, wherein said label identifier is a bar code having at least one dimension.

8. The system of claim 7, wherein said bar code has at least two dimensions.

9. The system of claim 1, wherein said application is further configured to notify a first trade partner of a status of said record.

10. The system of claim 9, wherein said first trade partner is determined by a defect type.

11. The system of claim 9, wherein said application is further configured to notify said first trade partner to perform repairs to said defect.

12. The system of claim 11, wherein said application is further configured to update said status of said record and notify a second trade partner to perform repairs to said defect.

13. The system of claim 12, wherein said application is further configured to notify said second trade partner after said first trade partner has performed repairs to said defect.

14. The system of claim 12, wherein said application is further configured to notify a builder of a status of said record.

15. The system of claim 14, wherein said application is further configured to notify said builder of said status after said second trade partner has performed repairs to said defect.

16. The system of claim 6, wherein said application is further configured to detect said first color of said one of said labels.

17. The system of claim 16, wherein said application is further configured to generate said trade identifier and said defect identifier from said label identifier based on said first color of said one of said labels.

18. A system for quality control management, comprising:
a) a server comprising a memory having a database;
b) a plurality of labels for identifying a construction defect, each of said labels comprising a unique label identifier; and
c) a mobile device operatively connected to said server, said mobile device comprising a camera;
wherein said server is configured to:
i) receive an image of a first of said labels from said mobile device and associate said label identifier with said first of said labels;
ii) associate a trade identifier and a defect identifier with said label identifier;
iii) maintain an electronic record of said defect in said database, said electronic record comprising a record identifier, a trade identifier, said defect identifier, and at least one attribute identifier associated with said defect; and
iv) associate one of a plurality of workflow processes with a defect type.

19. The system of claim 18, wherein according to said one of said workflow processes, said server is further configured to cause said mobile device to notify a first trade partner of a status of said record.

20. The system of claim 19, wherein said first trade partner is determined by a defect type.

21. The system of claim 19, wherein according to said one of said workflow processes, said server is further configured to cause said mobile device to notify said first trade partner to perform repairs to said defect.

22. The system of claim 21, wherein according to said one of said workflow processes, said server is further configured to cause said mobile device to notify a second trade partner to perform repairs to said defect in response to a change in said status of said record.

23. The system of claim 22, wherein according to said one of said workflow processes, said server is further configured to receive an indication, from said mobile device, that said first trade partner has performed repairs to said defect and cause said mobile device to notify said second trade partner.

24. The system of claim 22, wherein according to said one of said workflow processes, said server is further configured to cause said mobile device to notify a builder of a status of said record.

25. The system of claim 24, wherein according to said one of said workflow processes, said server is further configured to receive an indication, from said mobile device, that said second trade partner has performed repairs to said defect and cause said mobile device to notify said builder.

26. The system of claim 18, wherein a first color of one of said labels corresponds to a first trade category.

27. The system of claim 26, wherein said server is further configured to associate said trade identifier and said defect identifier with said label identifier based on said first color of said one of said labels.
